(19) United States
(12) Patent Application Publication
(10) Pub. No.: US 2005/0266128 A1
(43) Pub. Date: Dec. 1, 2005

(54) Novel method of preserving food products using pressure selective agents

(76) Inventors: James T.C. Yuan, Naperville, IL (US); Vasuhi Rasanayagam, Chicago, IL (US); Kazue Takeuchi, Darien, IL (US)

Correspondence Address: AIR LIQUIDE, 2700 POST OAK BOULEVARD, SUITE 1800, HOUSTON, TX, 77056, US

(21) Appl. No.: 11/118,203

(22) Filed: Apr. 28, 2005

Related U.S. Application Data
(60) Provisional application No. 60/566,210, filed on Apr. 28, 2004.

(51) Int. Cl. C12H 1/10

(52) U.S. Cl. 426/321

(57) ABSTRACT

A product containing a food product and a bioactive culture, and a treatment process for preserving a food or food product against microbiological contamination, which improves the quality of such food and enhances the safety of food and food products. The process applies a bioactive culture to the food and utilizes a pressure treatment process, optionally with a controlled atmosphere, to provide a reduction of the level of microorganisms, spores, or enzymes on and in foods or food products and suppress growth of pathogenic organisms that are not fully killed in the treatment process. The food or food product is generally contacted with the gas under pressure conditions for a time sufficient to substantially sanitize or disinfect the food or food product following depressurization.

### CROSS-REFERENCES

This application is related to and claims priority under 35 U.S.C. § 119(e) of U.S. Provisional Application Ser. No. 60/566,210 filed Apr. 28, 2004, the entire contents of which are incorporated herein by reference.

### BACKGROUND

The present invention relates to processes for preserving food or food products, and particularly to processes for preserving food or a food product against microbial contamination, using a pressure selective bioactive agent in combination with a pressure treatment process.

Food and food products, including packaged foods and food products, are generally subject to two main problems. Microbial contamination, and quality deterioration. The primary problem regarding food spoilage in public health is microbial growth. If pathogenic microorganisms are present, then growth of such microorganisms can potentially lead to food-borne outbreaks and significant economic losses. Since 1997, food safety concerns have increasingly been brought to the consumer's attention, and those concerns have become even stronger today. Recent outbreaks from Salmonella and E. coli 0157:H7 have increased the focus on food safety from a regulatory perspective, as well. A report issued from National Research Council (NRC) in 1988, indicated that there were approximately 9,000 human deaths a year from 81 million annual cases of food poisoning. A recent study completed by the Centers for Disease Control and Prevention (CDC) estimated that food-borne diseases cause approximately 76 million illnesses, 325,000 hospitalizations and 5,000 deaths annually in the U.S. Those numbers reveal the dramatic need for effective means for preserving food and food products in order to ensure food safety.

Currently, food manufacturers use different technologies, such as heating, to eliminate, retard, or prevent microbial growth. However, effective sanitation depends on the product/process type, and not all currently available technology can deliver an effective reduction of microorganisms. Instead, another level of health problems may be created, or the quality of the treated food may deteriorate. For example, chlorine has been widely used as a sanitizer of choice since World War I. However, concerns regarding the safety of carcinogenic and toxic byproducts of chlorine, such as chloramines and trihalomethanes, have been raised in recent years. Another example is heat treatment. Even though heat is very efficient in killing bacteria, it also destroys some nutrients, flavors, or textural attributes of food and food products.

Ozone has also been utilized as a means of reducing spoilage microorganisms in food and food products. Its effectiveness is generally compromised, however, by high reactivity and relatively short half-life in air. Ozone decomposition is also accelerated by water, certain organic and inorganic chemicals, the use of higher temperatures and pressures, contact with surfaces, particularly organic surfaces, and by turbulence, ultrasound and UV light. As a consequence, ozone is not generally suitable for storage for other than short periods of time. The use of gaseous ozone for the treatment of foods also presents certain additional problems, including non-uniform distribution of ozone in certain foods or under certain storage conditions. As a result, the potential exists for overdosing in areas close to an ozone entry location, while those areas remote from the entry location may have limited exposure to an ozone containing gas. A further important consideration in the use of ozone is the generally, relatively high cost associated with ozone generation on a commercial scale, including the costs associated with energy and the destruction of ozone in off-gas.

Similarly, carbon dioxide has been used as a means to inhibit the growth and metabolism of microorganisms, as well. See, e.g., the review of such studies presented in the Journal of Applied Bacteriology, 1989, 67, 109-136. The effect of CO₂ under pressure, and the release of pressure, upon bacteria has been investigated in other studies (see, e.g., the Journal of Bacteriology, Vol. XXVI, No. 2, 201-210, in which such effects were investigated for E. coli No. 463).

High pressure or ultra-high pressure processing (HPP) has also been applied to treat food and food products and to improve food safety against microbial contamination. In general, HPP treatment involves the high pressure processing of food to disrupt microbial cells or deactivate enzymes in the food. For example, in U.S. Pat. No. 5,393,547, a method is described for inactivating enzymes in food products by exposing the food to pressurized CO₂. However, the process requires that a carbonic acid solution be produced in the aqueous phase of the food by exposure of the food to CO₂ for a sufficient time such that a sufficiently low pH is produced to inactivate the enzymes. As exemplified, such times are at least one to two hours.

U.S. Pat. No. 6,331,272 further describes a method and membrane system for sterilizing and preserving liquids using CO₂. The method is said to destroy microorganisms and provide for the deactivation of enzymes by the use of a system, in which a flowing liquid, such as a juice, is contacted with the CO₂, the liquid and the CO₂ being separated by a porous membrane, e.g., a hollow fiber membrane. CO₂ is continuously re-circulated without depressurization at pressures said to be typically in the range of about 1,000 to about 3,000 psig.

Currently, food manufacturers process food using different technologies to kill microorganisms in food. The treated food either goes to further processing or packaging. One of the technologies used to kill, or reduce the amount of microorganisms present, is high pressure or ultra-high pressure processing (HPP). HPP applies high pressure to food to preserve the food (improve microbial safety) or change the physical and functional properties of the food. Even though HPP delivers promising results on food processing, in general, it possesses several concerns. Examples are its biocidal efficacy on spores and its effectiveness on enzymes. HPP is very effective in destroying vegetative cells of microorganisms, but not on bacterial spores. Also, HPP may enhance some unwanted enzymatic activities after the treatment.

In light of the foregoing problems associated with the treatment of foods against spores, and enzymes, a need exists for improvement in the sanitizing/disinfecting of foods and food products while at the same time maintaining, or improving the quality, and enhancing the safety of such foods.

### SUMMARY

The present invention provides a method of preserving foods and a food product that satisfies the need to provide food products with improved sanitation, particularly to suppress pathogenic microorganisms, bacterial spores, and enzymes on foods treated by pressure processing through a unique combination of a pressure selective bacterial agent and a pressure treatment. The process demonstrates improved biocidal efficacy, improves the quality of such food, and enhances the safety of food.

In accordance with one aspect of the invention, a method of treating a food or food product, and/or a packaged food, or packaged food product against microbial contamination is provided, wherein food or food product is treated with a bioactive culture, and subjected to a pressure treatment step. The bioactive culture is a non-pathogenic microorganism that is more resistant to pressure treatment processes, particularly high-pressure treatment processes, than pathogenic or spoilage microorganisms present on the food product, and inhibits the growth of the pathogenic or spoilage microorganisms on the food product. The bioactive culture may be, but is not necessarily, a lactic acid bacteria, Aerococcus, Microbacterium, Propionibacterium, or mixtures thereof. Typical lactic acid bacteria include Carnobacterium, Enterococcus, Lactococcus, Lactobacillus, Lactosphaera, Leuconostoc, Oenococcus, Pediococcus, Streptococcus, Vagococcus, and Weissella. The pressure treatment process provides an enclosure containing the food product, and applies a pressure to the enclosure so that the food product is subjected to pressure. In one embodiment, the method injects a treatment gas mixture comprising a primary gas, and/or a secondary gas into the enclosure, and then applies the pressure to the enclosure.

In other embodiments:
the bioactive culture is a liquid, or freeze-dried powder;
the pressure treatment is conducted at a temperature of between about 0° C. and about 200° C., or less than or equal to about 50° C.;
the food product is a solid or a liquid;
the primary gas is CO₂;
the secondary gas is nitrogen, carbon monoxide, nitric oxide, nitrous oxide, hydrogen, oxygen, helium, argon, krypton, xenon, neon, or mixtures thereof;
the treatment gas mixture contains about 5 to 100 mol % CO₂;
the treatment gas mixture consists of substantially only the primary gas and the secondary gas;
a vacuum is applied to the enclosure before applying pressure;
the food is subjected to a pressure of at least about 150 psig;
the pressure treatment includes a step of depressurizing to a second pressure of about 10 to 50 psig;
the pressure treatment subjects the food product to a pressure of at least about 1,000 psig;
the pressure treatment subjects the food product to a pressure of at least about 9,000 psig;
the pressure treatment subjects the food product to a pressure of at least about 35,000 psig;
the pressure treatment steps are repeated a sufficient number of times to sanitize the food product;
the secondary gas contains an inert gas and/or an anti-microbial gas; and
the pressure treatment step is at a temperature of equal to or less than about 50° C., the pressure is about 50 to about 250 psig, and the pressure treatment is repeated one or more times.

The current invention also provides a product that includes a food product manufactured and treated according to the inventive method described above.

The current invention further provides a product that includes a food product and a bioactive culture that is a non-pathogenic bioactive culture that inhibits the growth of the pathogenic microorganism.

The current invention provides a multi-technologies approach to reducing the level of microorganisms and enzymes associated with food and food products that have advantages over the use of a single technology. The inventive process therefore allows food processors to reduce the amount of additional processing needed, such as the temperature and/or amount of cooking time, with a resulting enhancement in food quality and safety.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 graphically shows the survival of L. monocytogenes (L. m) and L. plantarum (L. p) cultures after subjecting the cultures to a pressure treatment under a treatment gas mixture of one embodiment of the current invention.

### DESCRIPTION

In order to improve the quality and enhance the safety of food and food products, the current invention applies a non-pathogenic bioactive culture to the food product that is pressure resistant to the food, and exposes the food to a pressure treatment process. The two steps, and optionally a modified processing atmosphere, provide a synergistic effect on the control of microorganisms on and in foodstuffs, as well as a reduction of the level of microorganisms and undesirable enzymes.

It is known that many bacteria have the ability to repair themselves, especially if they are spore-formers. Spores are generally adaptive to even steam temperatures such that a single treatment may not be effective to kill or effectively reduce the level of microorganisms. Non-pathogenic bioactive cultures of the current invention are more resistant to high pressures than most pathogenic or spoilage microorganisms and are used to control such resistant spores and microorganisms. When bioactive cultures are incorporated into food processing under the high pressure treatment, there will be more bioactive culture bacteria survive than other spoilage or pathogenic microorganisms. This process selectively establishes the advantage of bioactive culture bacteria over others in a defined food environment. A modified atmosphere of the invention further enhances the growth advantage of bioactive culture bacteria. As used herein, “modified atmosphere” refers to an atmosphere comprising a treatment gas mixture of the current invention. The purpose of the modified atmosphere is to create an environment that favors the bioactive culture bacteria so that during the storage period of time (shelf life), the bioactive culture bacteria will outgrow any other spoilage or pathogenic microorganisms, inhibit their growth, and ensure food safety.

As used herein, “treatment gas mixture” refers to gases injected into the enclosure containing the food product. The treatment gas mixture may be any gas mixture that is beneficial to the food treatment process. One preferred treatment gas mixture is a mixture of a primary gas and a secondary gas. As used herein, “primary gas” can be any gas that is beneficial to the food treatment process. In one preferred embodiment, the primary gas is CO₂. As used herein, “secondary gas” refers to a component of the treatment gas mixture that is usually, but not necessarily, nitrogen, carbon monoxide, nitric oxide, nitrous oxide, hydrogen, oxygen, helium, argon, krypton, xenon, neon, a noble gas, or mixtures of any of the foregoing gases. Generally, inert gas or inert gases may be present during the pressure treatment. As used herein, the term “inert gas” refers to any non-oxidative or non-reactive gas, and includes gases such as nitrogen, argon, krypton, xenon, and neon or any mixture thereof. The primary or secondary gas may also contain an anti-microbial gas. As used herein, “anti-microbial gas” refers to any gas that has the effect of killing or reducing the activity of microorganisms on or in the food product.

In accordance with the present invention, a process is provided for treating a food or food product against microbial contamination by applying to the food a non-pathogenic bioactive culture that is pressure resistant, and disinfecting or sanitizing the food or food product by using a pressure treatment process. The bioactive culture treatment and pressure treatment may be used prior to, during all of, or a portion of a process for treating a food or food product, or thereafter, to eliminate or significantly reduce the content of microorganisms, bacteria or fungal spores, enzymes, or viruses in or on the food, or food product.

As used herein, the phrase “food or food product”, generally refers to all types of foods, including, but not limited to, meats, including ground meats, poultry, seafood, produce including vegetables and fruit, dry pasta, breads and cereals and fried, baked or other snack foods. The food may be in solid food product, a liquid food product, or combinations thereof. The current inventive method may be used in conjunction with any food that is able to support microbial, i.e. fungal, bacterial or viral growth, including unprocessed or processed foods. The food or food product must generally be compatible with the method of the current invention, particularly with the pressure treatment.

As used herein, the phrase “bioactive culture” refers to a culture of non-pathogenic microorganisms that are more resistant to pressure treatment than most pathogenic or spoilage microorganisms, and particularly are more resistant to pressure treatment than a pathogenic or spoilage microorganism or multiple pathogenic or spoilage microorganisms found on the target food product. The bioactive culture is preferably, but not necessarily, a lactic acid bacteria, Aerococcus, Microbacterium, Propionibacterium, or mixtures thereof. Preferred lactic acid bacteria include, but are not limited to, Carnobacterium, Enterococcus, Lactococcus, Lactobacillus, Lactosphaera, Leuconostoc, Oenococcus, Pediococcus, Streptococcus, Vagococcus, and Weissella. The bioactive culture may be applied in any form. For example, liquid, and/or freeze-dried powder, are two preferred forms. Because bioactive cultures of the current invention are more resistant to pressure treatment than most pathogenic or spoilage microorganisms, when they are applied to food and subjected to the pressure treatment, particularly high pressure treatment, there will be more bioactive culture bacteria survive than other spoilage or pathogenic microorganisms. This process selectively establishes the advantage of bioactive culture bacteria over other microorganisms on the food product. The bioactive culture is preferably, but not necessarily, applied before the pressure treatment.

As used herein, the phrase “pressure treatment”, refers to any process of treating a food product by placing the food in an enclosure and exposing it to elevated pressures. Preferred pressure treatment processes include, but are not limited to the methods of “high pressure processing” (HPP) as discussed in U.S. patent application Ser. No. 10/342,342 filed Jan. 15, 2003, or U.S. patent application Ser. No. 10/420,928, filed Feb. 19, 2004, the contents of both of which are incorporated herein by reference.

As used herein, the term “biocidal efficacy” generally refers to the effectiveness of a process to reduce the number of microorganisms on or in the food or food product, or to reduce the growth rate of microorganisms on or in the food or food product.

The terms “sanitize” and “disinfect”, as well as variations thereof, generally mean the reduction of the microbial and/or spore content of food. The terms “substantially sanitize” and “substantially disinfect” refer to the attainment of a level of microorganisms and/or spores in the food such that the food or food product is safe for consumption by a mammal, particularly by humans. Generally, as used herein, these terms refer to the elimination of at least about 90.0 to 99.9% of all microorganisms and/or spores, including pathogenic microorganisms, in the treated food or food product. Preferably, at least about 90.0 to 99.99%, and more preferably at least about 90.0 to 99.999% of such microorganisms and/or spores, are eliminated.

It is intended that the combination of the bioactive culture and pressure treatment provides a means of protecting a food or food product against microbial contamination. Generally, the term “microbial contamination” refers to undesired pathogenic and spoilage microorganisms. However, as the skilled artisan will appreciate, certain organisms may be desired (e.g. active yeasts) for particular foods, while the presence of such organisms in or on other foods may be undesirable. It is therefore not intended that all microbes necessarily be eliminated or reduced for all foods.

The application of a bioactive culture and pressure treatment in combination has a synergistic effect of reducing the level of activity of undesirable microorganisms that cause spoilage or impair the flavor of food. In this context, the process may provide for killing, reducing the number of, injuring, harming, or suppressing such microorganisms such that the growth rate or ability of the microorganisms to withstand additional anti-microbial treatments is reduced. By combining two or more treatment processes, the biocidal efficiency of the current method is synergistically improved as compared to only treating the food by application of one of the treatment processes.

The current method can be used at any processing temperatures at which the particular bioactive culture being used can survive. One preferred method treats the food product at about 0 to about 200° C. Another preferred embodiment treats the food at about 50° C. or below, and preferably between about 0 to about 50° C. Yet another preferred embodiment treats the food at about 40° C. or below, and preferably between about 0 to about 40° C.

The pressure treatment referenced herein applies a first pressure to expose the pathogenic microorganisms, spores, or enzymes to the elevated pressures. In one preferred embodiment, the first pressure is at least about 150 psig (10.2 atmospheres). In another embodiment, the first pressure is above about 1,000 psig (68 atmospheres). In yet another embodiment, the first pressure is above about 9,000 psig (612 atmospheres). In still another embodiment, the first pressure is at least about 35,000 psig (2,381 atmospheres). In still another embodiment, the first pressure is in a range of about 35,000 psig to about 45,000 psig (about 2,380 to about 3,060 atmospheres).

Some embodiments may include a step of applying a vacuum to the enclosure containing the food before the enclosure is pressurized to remove any unwanted gases from the enclosure.

After the first pressure is applied, the enclosure is depressurized. Although depressurization is typically performed by reducing the pressure to about atmospheric pressure, it is also possible to depressurize to a second pressure greater than atmospheric (within the range of about 10 to 50 psig). The pressurization to the first pressure may be followed by re-pressurization to start another pressure treatment cycle. It is preferred that such depressurization occurs rapidly, i.e., over a short period of time, typically on the order of seconds (e.g., from greater than 0 to about 15 seconds).

The pressure treatment steps of one embodiment are repeated a sufficient number of times effective to substantially sanitize the food product. The number of times the pressure treatment steps must be repeated to be effective in substantially sanitizing the food product will vary depending on the food, temperature, treatment gas mixture, pressure and time. The effective number of repeats can be determined by one of ordinary skill in the art without undue experimentation. For pressures above about 10,000 psig, it is preferred that more than one pressure treatment cycle be utilized. For pressures of less than about 250 psig, one or more pressure treatment cycles may be utilized. Combinations of one or more pressure treatment cycle(s) above about 10,000 psig with one or more pressure treatment cycle(s) at pressures of less than about 250 psig are also possible. The food product may be optionally packaged before or after treatment.

Although not intended to be bound by a theoretical understanding of the effects of pressure treatment on microorganisms, it is thought that high pressure increases the solubility of gas in microbial cells such that a sharp drop in pressure at the end of the pressure treatment cycle causes gas to form in the cells as the gas solubility decreases, thereby causing a bursting of the cell walls and irreversible death of the cells. By the application of more than one treatment cycles, the biocidal efficacy of pressure treatment may be increased significantly.

In one preferred embodiment of the invention, a food or food product is treated by applying a bioactive culture, placing the food into an enclosure, injecting an effective amount of a treatment gas mixture containing a primary gas and a secondary gas, and applying a first pressure to the enclosure for a time sufficient to substantially sanitize or disinfect the food in the enclosure. Alternate embodiments may inject only a primary gas or only a secondary gas as the treatment gas mixture. The treatment gas mixture forms a modified atmosphere, which enhances the growth advantage of the bioactive bacteria. Pressure treating the food in a modified atmosphere, further favors the bioactive culture bacteria. Furthermore, the food may be packaged under a modified atmosphere as described above, further favoring the growth of the bioactive culture during the storage period (shelf life) of the food. Bioactive cultures are selected that will outgrow any undesirable spoilage or pathogenic microorganisms and inhibit the growth of those undesirable microorganisms and enzymes under the modified atmosphere. The growth of bioactive cultures, such as L. plantarum, on food also produces bacterosin, which effectively inhibit pathogenic microorganisms, such as L. monocytogenus, during storage. Consequently, the freshness of the food is improved, and food safety is ensured.

In one embodiment, the food is contacted with a treatment gas mixture and/or a pressure treatment for a time sufficient to substantially sanitize or disinfect the foodstuff. While the time periods necessary to achieve sanitation will vary depending on the particular food or food product, whether the food or food product is packaged, the type of microorganism treated, and the amount of subsequent treatment the food is intended to be subjected to, e.g., cooking or additional pressure treatment cycles. In general, the time period per pressure treatment cycle ranges from about 5 seconds to about 1 hour, preferably from about 15 seconds to about 30 minutes, and more preferably, from about 15 seconds to about 10 minutes. The amount of treatment time for spores is generally greater. In one preferred embodiment, the treatment gas mixture contains a primary gas, preferably CO₂, and even more preferably at a concentration of about 5 to 100 mol %. The treatment gas mixture may, but not necessarily, contain only primary gas, only secondary gas, or contain a mixture of primary gas and secondary gas.

One embodiment of the current invention provides a product that is produced by treating a food product by any of the methods described above.

In another embodiment of the current invention, a product is provided that includes a food product and a bioactive culture. The bioactive culture is a non-pathogenic bioactive culture that is more resistant to pressure treatment, particularly high pressure treatment, than a pathogenic or spoilage microorganism or multiple pathogenic microorganisms that are present on the food product. Preferably the bioactive culture is a non-pathogenic bioactive culture that is more resistant to pressure treatment, particularly high pressure treatment, than most pathogenic or spoilage microorganisms. Furthermore, the bioactive culture inhibits the growth of the pathogenic microorganism both before and after the food product has been pressure treated. Thus, the bioactive culture continues to protect the food product during storage and distribution to the final consumer. The bioactive culture can be any bioactive culture previously described herein.

The food or food product may be subjected to a batch treatment with the treatment gas mixture, or may be contacted with the treatment gas mixture in a continuous or semi-batch process. A suitable treatment gas mixture concentration for use in such a batch, continuous, or semi-batch process is in the range of about 0.2% to 100% for the exposure periods noted above. Other combinations of treatment gas mixture concentrations and exposure periods may also be used, however, if desired, to sanitize/disinfect the food or food product. Means for increasing the contact of the treatment gas mixture with the food, such as, gas diffusers for liquids, or means for injecting gas into a solid or liquid food or food product, may also be utilized. In one aspect of the invention, the food or food product may be exposed to the gas by injection of the gas into the food or food product or by injection of gas into the ambient atmosphere surrounding the food or food product and/or injecting the gas into a container containing the food or food product.

The current treatment method may also be combined with other processes. For example, a cooking process, such as in an oven or other closed, or controlled environment, may be utilized in addition to the current treatment method. Other heat treatment cooking processes, such as grilling (e.g. in the case of meats and other suitable foods), boiling, or frying, may be utilized without limitation in conjunction with or following the current treatment method. The cooking process may include other known cooking steps or processes, such as microwave treatment, or convective or radiative heating. The use of heated gases, including steam, is also possible, and may be preferred for certain foods. Such cooking processes may also be conducted at atmospheric pressure, under vacuum, or at a pressure up to about 300,000 psig. A gaseous atmosphere comprising air, oxygen, carbon dioxide, carbon monoxide, nitrogen, argon, or mixtures thereof, may also be utilized during the cooking process.

The use of additional expensive processing techniques, such as membrane contactors according to U.S. Pat. No. 6,331,272, is not required in the present invention, and is preferably excluded.

The process of the current invention may optionally include packaging of the food or food product comprising placing the food or food product in a container and sealing the container. A vacuum may be optionally applied to the container to remove air or other gas from the container. A purge gas may be further optionally injected into the container, either with or without the use of a vacuum step. The purge gas may be applied before, after or both before and after the use of a vacuum step. The purge gas may be nitrogen, carbon dioxide, carbon monoxide, argon, krypton, xenon, neon or a mixture thereof.

In a preferred embodiment, the food or food product is treated by the current treatment method and subsequently placed in a container. A vacuum is applied to the container to remove air or other gas from the container and the container is sealed to maintain the vacuum in the container.

The container used to contain the food or food product is not particularly limited and includes disposable and reusable containers of all forms, including those that may be microwavable and/or oven-proof. The container may include a cover or cap designed for the container or may be closed or sealed with a permeable or impermeable film or metal foil.

The present invention may be advantageously used to destroy viruses, bacteria and/or fungi. Preferably, the microorganisms destroyed are those causing food-borne illnesses. As used herein, the term “food-borne” illness means any single or combination of illnesses caused by microorganisms in mammals consuming foods containing those microorganisms.

Examples of bacteria causing such illnesses are various species of Salmonella, Staphylococcus, Streptococcus and Clostridium. For example, Escherichia coli, including E. coli 0157:H7, Salmonella typhimurium, Salmonella Schottmulleri, Salmonella choleraesuis, Salmonella enteritidis, Staphylococcus aureus, Streptococcus faecalis, Clostridium botulinum and Clostridium perfringens may be noted.

The present invention may be advantageously used against any bacteria that produce a toxin, enzyme, or both as a mechanism of pathogenicity. For example, hyaluronidase, an enzyme that digests the intracellular cement, hyaluronic acid, is produced by some pathogenic strains of Staphylococci, Streptococci and Clostridia.

As examples of toxins, the neurotoxin of Clostridium botulinum and the enterotoxin produced by Staphylococcus aureus may be noted.

Examples of fungi causing mycotoxicosis, a collective term for diseases induced by consumption of food made toxic by the growth of various fungi, are Aspergillus flavus in peanuts, peanut butter, rice, cereal grains and beans, which can produce any one of the many known aflatoxins. Another example is Aspergillus ochraceus, which may grow in corn, grain, peanuts, Brazil nuts, and cottonseed meal, and can produce the toxins, ochratotoxin A and B. Yet another example is a mycotoxin released by Penicillium toxicarium growing on rice that causes paralysis, blindness and death in experimental animals. Still another example is Fusarium graminearum.

Having described the present invention, reference will now be made to the example provided solely for the purposes of illustration. This example is not to be interpreted as limiting the scope of the invention or the claims.

### EXAMPLE

Listeria monocytogenes (L.m) strains (101 M, F6854, H7776) were grown individually in tryptic soy broth (TSB). Three strains were mixed in equal ratio and used as inoculum. Lactobacillus plantarum (L.p) 8014 (American Tissue Culture Collection, Manassas, Va.) was maintained in MRS broth (Difco) at 4° C. Cultures were activated at 35° C. for 24 hours in MRS broth.

A 15 cm diameter agar disk (15 g of agar dissolved in de-ionized water, sterilized for 15 minutes, poured on petri dishes and stored at 4° C.) was used as a carrier for the inoculum in order to prevent nutritional support for the growth and repair of the microorganisms during the storage period. Each agar disk was inoculated with 0.1 ml of cocktail culture or pure culture and it was spread evenly using a hockey stick. The disks were air dried under the laminar flow hood for at least 30 minutes. Each disk was placed into a high barrier Nylon pouch and vacuumed and filled with appropriate pure or mixed gas of 40 cm³ and sealed using a heat sealer. Then each pouch was placed inside another bigger pouch and this outer pouch was vacuum-sealed. Pouches were stored at 2° C. for overnight prior to the pressure treatment.

The water-jacketed pressure vessel was preheated to the desired process temperature while the pressure transmitting medium and the samples were pre-equilibrated to the initial temperature in an external water bath. Compression heating during the pressurization process produced an increase in the temperatures, thus, there are two temperatures to be considered during these tests: 1) the initial temperature prior to the high pressure process, and 2) the process temperature of the sample and the medium under pressure (Tₚ). The initial temperature used to achieve each particular pressure (P) and Tₚ combination was determined through preliminary tests. Samples were placed in the stainless steel basket along with pressure transfer medium. The vessel was then closed and the pressure was generated by compression using a piston. Once the pressure reached the target pressure, it was held at that pressure for predetermined process time (process time did not include the come-up time and the depressurization time). At the end of the process time, the pressure was released and samples were cooled immediately by placing on ice slurry.

Survival was determined by direct enumeration on Palcam base medium (without the addition of antimicrobial agent) for L. monocytogenes and pour plate method with MRS media for L. plantarum. Unprocessed samples and samples treated under pressure with and without a treatment gas mixture present were kept at 2° C. during the storage study. Unprocessed samples were plated on the initial day of the preparation of the samples (Day 0) and used as the initial count to calculate the log-reduction. Two samples of each condition (processed with pressure treatment and unprocessed) were opened and plated on days 1 (1^{st} Day of the pressure treatment), 4, 8, 11 and 15 of the experiment.

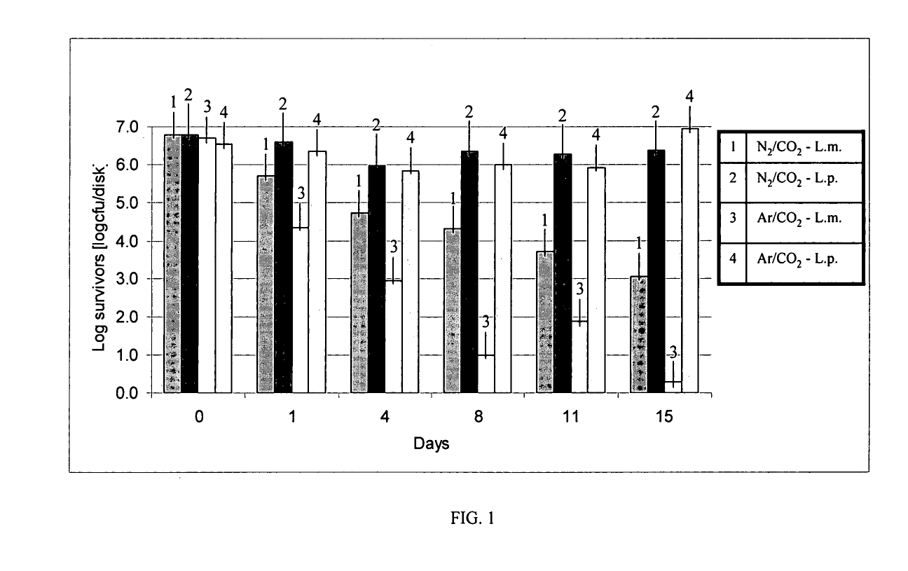

FIG. 1 shows the survival of L. monocytogenes (L.m.) 1, 3 in the plated mixture of L. monocytogenes and L. plantarum (L.p.) after pressure treatment under modified atmospheres of 30 mole % CO₂ with 70 mole % nitrogen and 30 mole % CO₂ with 70 mole % argon. The samples were treated at 40,000 psig (272 MPa), 40° C. for 1 minute and stored at 4° C. for 15 days. As shown in FIG. 1, L. plantarum 2, 4 is more resistant to the high pressure treatment than L. monocytogenes 1, 3.

While the invention has been described in detail by reference to specific embodiments, the skilled artisan will appreciate that various modifications, substitutions, omissions and changes may be made, and equivalents employed, without departing from the spirit of the invention or the scope of the appended claims.

1. A method of treating a food product against microbial contamination, the method comprising the steps of:
a) applying a bioactive culture to a food product; and
b) subjecting said food product to a pressure treatment, wherein said bioactive culture is a non-pathogenic bioactive culture, and wherein said bioactive culture inhibits growth of a pathogenic microorganism.

2. The method of claim 1, wherein said bioactive culture is selected from the group consisting of:
a) a lactic acid bacteria;
b) Aerococcus;
c) Microbacterium;
d) Propionibacterium; and
e) mixtures thereof.

3. The method of claim 2, wherein said lactic acid bacteria is selected from the group consisting of:
a) Carnobacterium;
b) Enterococcus;
c) Lactococcus;
d) Lactobacillus;
e) Lactosphaera;
f) Leuconostoc;
g) Oenococcus;
h) Pediococcus;
i) Streptococcus;
j) Vagococcus;
k) Weissella; and
l) mixtures thereof.

4. The method of claim 1, wherein said bioactive culture is in a form selected from the group consisting of:
a) a liquid;
b) a freeze-dried powder; and
c) combinations thereof.

5. The method of claim 1, wherein said pressure treatment is conducted at a temperature of between about 0° C. and about 200° C.

6. The method of claim 1, wherein said pressure treatment is conducted at a temperature of equal to or less than about 50° C.

7. The method according to claim 1, wherein said pressure treatment subjects the food product to a pressure of at least about 1,000 psig.

8. The method according to claim 7, wherein said pressure is at least about 9,000 psig.

9. The method according to claim 7, wherein said pressure is at least about 35,000 psig.

10. The method of claim 1, wherein said pressure treatment comprises the steps of:
a) providing an enclosure containing said food product;
b) injecting into said enclosure a treatment gas mixture comprising a primary gas, and a secondary gas; and
c) applying a first pressure to said enclosure so as to subject said food product to said first pressure.

11. The method of claim 10, wherein said primary gas is CO₂.

12. The method of claim 11, wherein said secondary gas is selected from the group consisting of:
a) nitrogen;
b) carbon monoxide;
c) nitric oxide;
d) nitrous oxide;
e) hydrogen;
f) oxygen;
g) helium;
h) argon;
i) krypton;
j) xenon;
k) neon; and
l) mixtures thereof.

13. The method of claim 12, wherein said bioactive culture is selected from the group consisting of:
a) a lactic acid bacteria;
b) Aerococcus;
c) Microbacterium;
d) Propionibacterium; and
e) mixtures thereof.

14. The method of claim 13, wherein said lactic acid bacteria is selected from the group consisting of:
a) Carnobacterium;
b) Enterococcus;
c) Lactococcus;
d) Lactobacillus;
e) Lactosphaera;
f) Leuconostoc;
g) Oenococcus;
h) Pediococcus;
i) Streptococcus;
j) Vagococcus;
k) Weissella; and
l) mixtures thereof.

15. The method of claim 12, wherein said bioactive culture is in a form selected from the group consisting of:
a) a liquid;
b) a freeze-dried powder; and
c) combinations thereof.

16. The method of claim 12, wherein said treatment gas mixture comprises from about 5 to about 100 mol % CO₂.

17. The method of claim 16, wherein said treatment gas mixture consists of CO₂ and said secondary gas.

18. The method of claim 12, wherein said pressure treatment is conducted at a temperature of between about 0° C. and about 200° C.

19. The method of claim 12, wherein said pressure treatment is conducted at a temperature of less than about 50° C.

20. The method of claim 12, comprising the further step of applying a vacuum to said enclosure before applying said first pressure.

21. The method of claim 12, wherein said first pressure is at least equal to or greater than about 150 psig.

22. The method according to claim 12, wherein said first pressure is equal to or greater than about 1,000 psig, and where said pressure treatment further comprises a step of depressurizing to a second pressure in a range of about 10 to about 50 psig.

23. The method according to claim 12, wherein said first pressure is equal to or greater than about 9,000 psig, and where said pressure treatment further comprises a step of depressurizing to a second pressure in a range of about 10 to about 50 psig.

24. The method according to claim 12, wherein said pressure treatment steps are repeated a sufficient number of times effective to substantially sanitize the food product.

25. The method according to claim 12, wherein said secondary gas further comprises a gas selected from the group consisting of:
a) an inert gas;
b) an anti-microbial gas; and
c) mixtures thereof.

26. The method according to claim 12, wherein said pressure treatment step is conducted at a temperature of equal to or less than about 50° C., wherein said first pressure is in the range of about 25 to about 250 psig, and wherein said pressure treatment is repeated one or more times.

27. A product manufactured according to a method comprising the steps of supplying a food product, applying a bioactive culture to said food product, and subjecting said food product to a pressure treatment.

28. The product of claim 27, wherein said bioactive culture is selected from the group consisting of:
a) a lactic acid bacteria;
b) Aerococcus;
c) Microbacterium;
d) Propionibacterium; and
e) mixtures thereof.

29. The product of claim 28, wherein said lactic acid bacteria is selected from the group consisting of:
a) Carnobacterium;
b) Enterococcus;
c) Lactococcus;
d) Lactobacillus;
e) Lactosphaera;
f) Leuconostoc;
g) Oenococcus;
h) Pediococcus;
i) Streptococcus;
j) Vagococcus;
k) Weissella; and
l) mixtures thereof.

30. The product of claim 29, wherein said pressure treatment comprises the steps of providing an enclosure containing said food product, injecting into said enclosure a treatment gas mixture comprising a primary gas and a secondary gas, and applying a first pressure to said enclosure so as to subject said food product to said first pressure.

31. The product of claim 30, wherein said primary gas is CO₂.

32. The product of claim 31, wherein said secondary gas is selected from the group consisting of:
a) nitrogen;
b) carbon monoxide;
c) nitric oxide;
d) nitrous oxide;
e) hydrogen;
f) oxygen;
g) helium;
h) argon;
i) krypton;
j) xenon;
k) neon; and
l) mixtures thereof.

33. A product comprising a food product and a bioactive culture, wherein said bioactive culture is a non-pathogenic bioactive culture that is more resistant to pressure treatment than a pathogenic microorganism, and wherein said bioactive culture inhibits growth of said pathogenic microorganism.

34. The product of claim 33, wherein said bioactive culture is selected from the group consisting of:
a) a lactic acid bacteria;
b) Aerococcus;
c) Microbacterium;
d) Propionibacterium; and
e) mixtures thereof.

35. The product of claim 34, wherein said lactic acid bacteria is selected from the group consisting of:
a) Carnobacterium;
b) Enterococcus;
c) Lactococcus;
d) Lactobacillus;
e) Lactosphaera;
f) Leuconostoc;
g) Oenococcus;
h) Pediococcus;
i) Streptococcus;
j) Vagococcus;
k) Weissella; and
l) mixtures thereof.
